(19) United States
(12) Patent Application Publication
(10) Pub. No.: US 2012/0327352 A1
(43) Pub. Date: Dec. 27, 2012

(54) LIQUID CRYSTAL DISPLAY APPARATUS

(76) Inventors: Nami UYAMA, Hakusan-shi (JP); Tatsuya Wakimoto, Hakusan-shi (JP); Norihisa Maeda, Nonoichi-shi (JP); Shigesumi Araki, Hakusan-shi (JP); Kazuhiro Nishiyama, Kanazawa-shi (JP)

(21) Appl. No.: 13/413,875

(22) Filed: Mar. 7, 2012

(30) Foreign Application Priority Data
Jun. 27, 2011 (JP) 2011-141803

(51) Int. Cl. G02F 1/1343

(52) U.S. Cl. 349/141

(57) ABSTRACT

According to one embodiment, a liquid crystal display apparatus includes a first substrate including a pixel electrode including comb-like projections extending in a first direction and arranged in a second direction substantially perpendicular to the first direction, a common electrode including comb-like projections extending in the first direction between the comb-like projections of the pixel electrode and arranged with a predetermined spacing from the comb-like projections of the pixel electrode, a second substrate arranged opposite to the first substrate, and a liquid crystal layer sandwiched between the first substrate and the second substrate. A space width between the comb-like projection of the pixel electrode and the comb-like projection of the common electrode of end portion in the second direction is greater than a space width between the comb-like projection of the pixel electrode and the comb-like projection of the common electrode in a center portion.

### CROSS-REFERENCE TO RELATED APPLICATIONS

This application is based upon and claims the benefit of priority from prior Japanese Patent Application No. 2011-141803, filed Jun. 27, 2011, the entire contents of which are incorporated herein by reference.

### FIELD

Embodiments described herein relate generally to a liquid crystal display apparatus.

### BACKGROUND

In recent years, flat-screen display apparatuses have been actively developed and, among others, liquid crystal display apparatuses are being applied in various fields by exploiting as much as possible such characteristics as lightness, slimness, and low power consumption. Such a liquid crystal display apparatus is configured by sandwiching a liquid crystal layer between a pair of substrates, an image being displayed by controlling a percentage modulation of light passing through the liquid crystal layer by means of an electric field between a pixel electrode and a common electrode.

For liquid crystal display apparatuses, a method of controlling an orientation state of the liquid crystal by applying a longitudinal electric field in a direction substantially perpendicular to a substrate surface of the pair of substrates and a method of controlling the orientation state of the liquid crystal by applying a transverse electric field (including a fringe electric field) in a direction substantially parallel to the substrate surface of the pair of substrates are known.

Particularly, liquid crystal display apparatuses using the transverse electric field attract attention in terms of making the angle of visibility wider. A liquid crystal display apparatus of the transverse electric field method such as an in-plane switching (IPS) mode and a fringe field switching (FFS) includes a pixel electric field and a common electric field formed in a first substrate.

In a liquid crystal display apparatus of the IPS mode, a pixel electrode and a common electrode are arranged side by side with a spacing therebetween in a direction substantially parallel to a substrate surface and the orientation state of liquid crystal molecules is controlled by a transverse electric field generated between the pixel electrode and the common electrode.

### BRIEF DESCRIPTION OF THE DRAWINGS

FIG. 1 is a diagram schematically showing a configuration example of a liquid crystal display apparatus according to an embodiment;

FIG. 2 is a diagram schematically showing a configuration example of a display pixel of the liquid crystal display apparatus according to an embodiment;

FIG. 3 is a diagram illustrating a configuration example of a pixel electrode and a common electrode of a display pixel of a liquid crystal display apparatus according to a first embodiment;

FIG. 4 is a diagram showing an example of an evaluation result of the liquid crystal display apparatus according to the first embodiment;

FIG. 5 is a diagram illustrating a configuration example of a pixel electrode and a common electrode of a display pixel of a liquid crystal display apparatus according to a second embodiment;

FIG. 6 is a diagram showing an example of an evaluation result of the liquid crystal display apparatus according to the second embodiment;

FIG. 7 is a diagram illustrating a configuration example of a pixel electrode and a common electrode of a display pixel of a liquid crystal display apparatus according to Comparative Example; and

FIG. 8 is a diagram showing an example of an evaluation result of the liquid crystal display apparatus according to Comparative Example.

### DETAILED DESCRIPTION

In general, according to one embodiment, a liquid crystal display apparatus comprises a first substrate that comprises a plurality of pixel electrodes including a plurality of comb-like projections extending in a first direction and arranged in a second direction substantially perpendicular to the first direction, a plurality of common electrodes including a plurality of comb-like projections extending in the first direction between the comb-like projections of the pixel electrode and arranged with a predetermined spacing from the comb-like projections of the pixel electrode, a scanning line extending along the second direction, and a signal line extending along the first direction; a second substrate arranged opposite to the first substrate; and a liquid crystal layer sandwiched between the first substrate and the second substrate. A space width between the comb-like projection of the pixel electrode and the comb-like projection of the common electrode arranged near the signal line in the second direction is greater than a space width between the comb-like projection of the pixel electrode and the comb-like projection of the common electrode in a center portion between the adjacent signal lines.

Liquid crystal display apparatuses according to embodiments will be described below with reference to drawings.

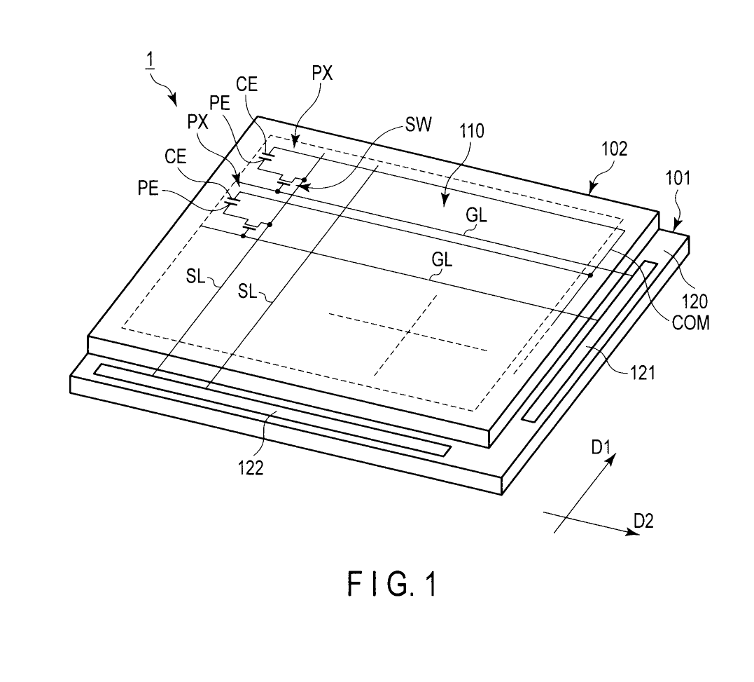

FIG. 1 schematically shows a configuration example of a liquid crystal display apparatus 1 according to the first embodiment. The liquid crystal display apparatus 1 according to the present embodiment is a normally black liquid crystal display apparatus of the IPS mode and includes a pair of substrates opposite to each other, that is, a first substrate 101 and a second substrate 102, a liquid crystal layer (not shown) sandwiched between the first substrate 101 and the second substrate 102, and a display region 110 including display pixels PX arranged in a matrix form.

The first substrate 101 and the second substrate 102 are optically transparent insulating substrates and, for example, glass substrates.

In the display region 110, the first substrate 101 includes a plurality of scanning lines GL extending along a row direction (second direction) D2 in which the display pixels PX are arrayed, a plurality of signal lines SL extending along a column direction (first direction) D1 in which the display pixels PX are arrayed, a pixel switch SW arranged near an intersection position of the scanning line GL and the signal line SL, a plurality of pixel electrodes PE arranged in each display pixel PX, and a common electrode CE arranged so as to form a transverse electric field between the plurality of pixel electrodes PE and the common electrode CE.

On the first substrate 101, a gate driver 121 and a source driver 122 are arranged in a peripheral of the display region 110. The plurality of scanning lines GL is connected to the gate driver 121 by extending to the peripheral of the display region 110. The plurality of signal lines SL is connected to the source driver 122 by extending to the peripheral of the display region 110.

The gate driver 121 sequentially drives the plurality of scanning lines GL to cause conduction between a source and a drain of the pixel switch SW connected to the scanning line GL. The source driver 122 supplies a video signal to the plurality of signal lines SL. The video signal supplied to the signal line SL is supplied to the pixel electrode PE via the corresponding pixel switch. A common voltage is fed to the common electrode CE via a common wire COM.

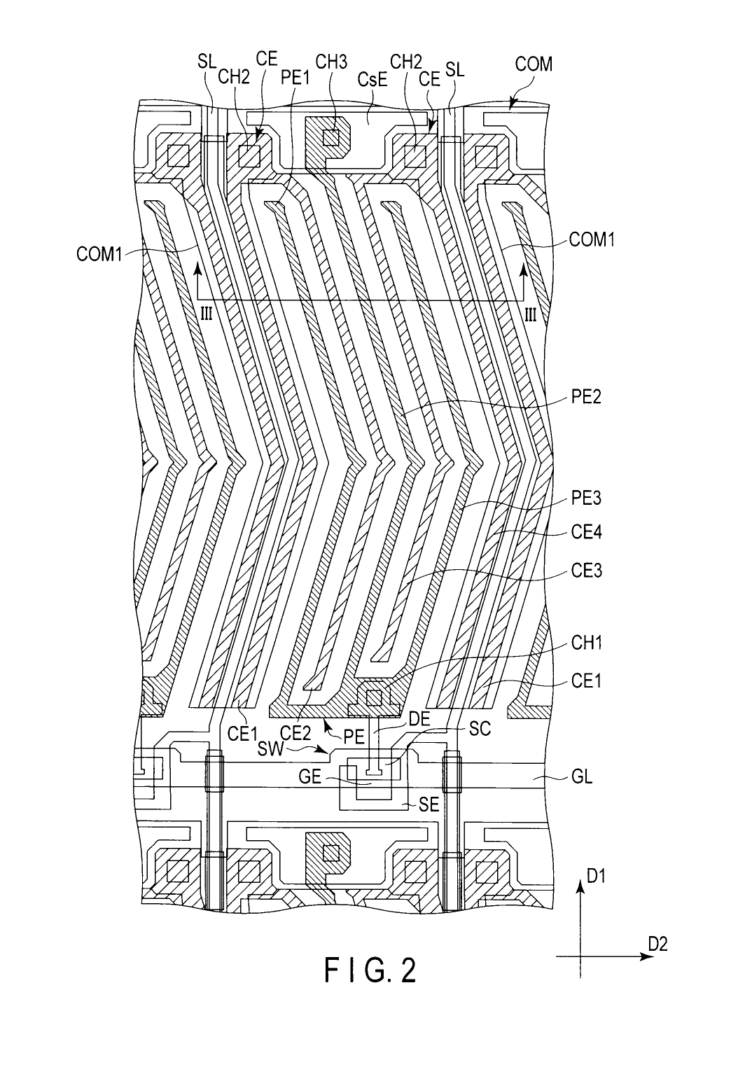

FIG. 2 shows a plan view illustrating a configuration example of the display pixel PX.

The pixel switch SW is, for example, a thin-film transistor containing a semiconductor layer SC of amorphous silicon. Incidentally, the pixel switch SW may be a thin-film transistor containing a semiconductor layer of polysilicon. A gate electrode GE of the pixel switch SW is electrically connected to the corresponding scanning line GL (or integrally formed). A source electrode SE of the pixel switch SW is electrically connected to the corresponding signal line SL (or integrally formed). In the liquid crystal display apparatus 1 according to the present embodiment, the pixel switch SW includes two source electrodes. A drain electrode DE of the pixel switch SW is connected to the corresponding pixel electrode PE via a contact hole CH1.

The electrical connection of the pixel electrode PE to the signal line SL is switched by the pixel switch SW whose gate potential is controlled by the scanning line GL arranged on one side in the column direction D1. The pixel electrode PE is also electrically connected by an auxiliary capacitance electrode CsE and a contact hole CH3 arranged on the other side in the column direction D1.

The pixel electrode PE is formed in a comb shape from a transparent electrode material such as indium tin oxide (ITO) and indium zinc oxide (IZO) and includes a plurality of comb-like projections PE1 to PE3 extending substantially in parallel with the column direction D1 in which the display pixels PX are arrayed. The plurality of comb-like projections PE1 to PE3 extends in a > shape by being bent in a substantial center portion in the longitudinal direction (column direction D1) of the display pixels PX.

The common electrode CE is formed in a comb shape from a transparent electrode material such as ITO and IZO and includes a plurality of comb-like projections CE1 to CE4 extending substantially in parallel with the column direction D1 in which the display pixels PX are arrayed. The plurality of comb-like projections CE1 to CE4 extends in a > shape by being bent in the substantial center portion in the longitudinal direction (column direction D1) of the display pixels PX. The common electrode CE is electrically connected to the common wire COM and a contact hole CH2 described later.

While the signal line SL is shown as a straight line in FIG. 1, as shown in FIG. 2, the signal line SL extends, like the shape of comb-like projections PE1 to PE3 of the pixel electrode PE and comb-like projections CE1 to CE4 of the common electrode CE, by being bent in the substantial center portion in the longitudinal direction of the display pixels PX.

The common wire COM is arranged by extending substantially in parallel with the direction (row direction D2) in which the scanning line GL extends in the same layer as the scanning line GL. The common wire COM is electrically connected to the common electrodes CE arranged in a plurality of display pixels PX arrayed in the row direction D2 to apply a common voltage to these common electrodes CE.

The common wire COM also includes a light shielding portion COM1 arranged by extending to a lower layer of comb-like projections CE1 and CE4 arranged on both sides of the signal line SL and the signal line SL. The light shielding portion COM1 is arranged, together with a light shielding layer BM of the second substrate 102 described later, so as to prevent light from transmitting between the display pixels PX.

The auxiliary capacitance electrode CsE is arranged opposite to the common wire COM. The auxiliary capacitance electrode CsE is arranged in the same layer as the signal line SL and is electrically connected to comb-like projection PE2, which is one electrode of the pixel electrode PE, via contact hole CH3. An auxiliary capacitance Cs is formed between the auxiliary capacitance electrode CsE and the common wire COM.

Comb-like projections PE1 to PE3 of the pixel electrode PE and comb-like projections CE1 to CE4 of the common electrode CE are alternately arranged with a predetermined spacing therebetween in the row direction D2 in which the display pixels PX are arrayed.

In the display region 110, the second substrate 102 includes the light shielding layer BM arranged in a lattice shape so as to be opposite to the signal line SL and the scanning line GL and a light shielding layer (not shown) arranged as if to surround the display region 110. If the liquid crystal display apparatus is a color display type apparatus, the second substrate 102 includes a color filter layer (not shown).

The color filter layer includes a red color filter (not shown) that allows light a red main wavelength to pass through, a green color filter (not shown) that allows light a green main wavelength to pass through, and a blue color filter (not shown) that allows light a blue main wavelength to pass through. Each of color filters of a plurality of colors is arranged opposite to one pixel electrode PE.

A pair of orienting films (not shown) opposite via the liquid crystal layer are arranged on the first substrate 101 and the second substrate 102. The surface of the orienting film has been orientation-treated such as rubbing treatment and optical orientation treatment to regulate an initial orientation state of liquid crystal molecules contained in the liquid crystal layer. The orientation state of the liquid crystal layer is controlled by a transverse electric field generated by a potential difference between a video signal supplied to comb-like projections PE1 to PE3 and the common voltage supplied to comb-like projections CE1 to CE4.

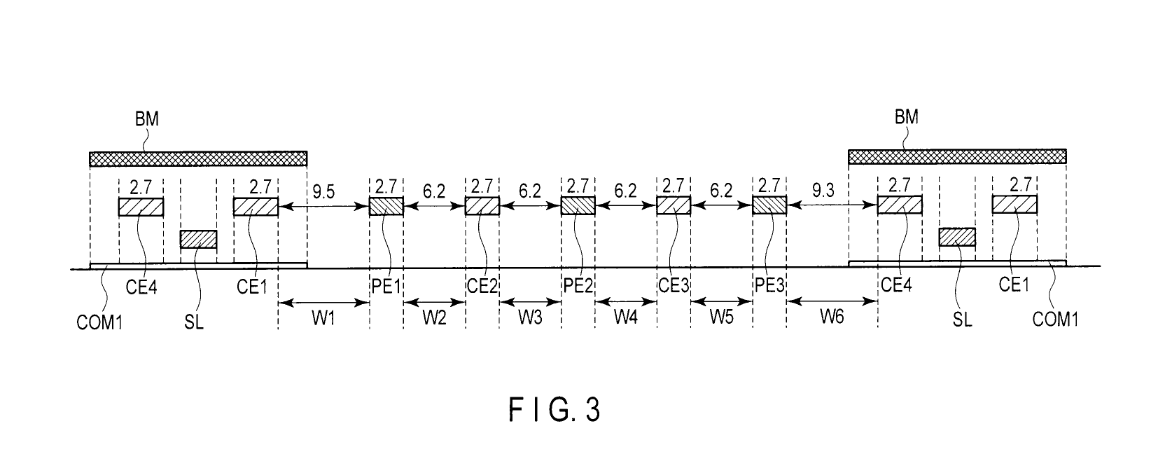

FIG. 3 schematically shows the arrangement positions of the pixel electrodes PE and the common electrodes CE in the section along line III-III in FIG. 2. In FIG. 3, the light shielding portion COM1 of the common wire COM, comb-like projections PE1 to PE3 of the pixel electrode PE, comb-like projections CE1 to CE4 of the common electrode CE, the signal lines SL, and the light shielding layers are illustrated and other elements are omitted.

In the row direction D2, the width of comb-like projections PE1 to PE3 and comb-like projections CE1 to CE4 is substantially 2.7 μm and the width of the signal line SL is substantially 3.0 μm. Comb-like projections CE1 and CE4 and the signal line SL are arranged between the light shielding layer BM and the light shielding portion COM1.

As shown in FIG. 3, the space widths between comb-like projections PE1 to PE3 of the pixel electrode PE and comb-like projections CE1 to CE4 of the common electrode CE in the row direction D2 in which the display pixels PX are arrayed are different between the pixel center portion and a pixel edge.

In the present embodiment, space widths W1 and W6 between comb-like projections PE1 and PE3 and comb-like projections CE1 and CE4, respectively, near the signal line SL in the row direction D2 are greater than space widths W2, W3, W4 and W5 between comb-like projections PE1 to PE3 and comb-like projections CE2 and CE3 near the center portion between the adjacent signal lines SL in the row direction D2.

In the pixel, space widths W1 and W6 between comb-like projections PE1 and PE3 and comb-like projections CE1 and CE4, respectively, near the end portion in the row direction D2 are greater than space widths W2, W3, W4 and W5 between comb-like projections PE1 to PE3 and comb-like projections CE2 and CE3 near the center portion in the row direction D2.

The space widths between comb-like projections PE1 and PE3 and comb-like projections CE1 and CE4, respectively, near the signal line SL in the row direction D2 are space width W6 between the first comb-like projection CE4 and the first comb-like projection PE3 from the side of the signal line SL supplying a video signal to the pixel electrode PE via the pixel switch SW and space width W1 between the fourth comb-like projection CE1 and the third comb-like projection PE1.

That is, space width W1 between comb-like projection CE1 arranged on the side of the signal line SL supplying a video signal to the pixel electrode PE of the adjacent display pixel PX of each display pixel PX and comb-like projection PE1 arranged adjacent to comb-like projection CE1 and space width W6 between comb-like projection CE4 arranged on the side of the signal line SL supplying a video signal to the pixel electrode PE of the display pixel PX and comb-like projection PE3 arranged adjacent to comb-like projection CE4 are greater than space width W2 between comb-like projection PE1 and comb-like projection CE2, space width W3 between comb-like projection CE2 and comb-like projection PE2, space width W4 between comb-like projection PE2 and comb-like projection CE3, and space width W5 between comb-like projection CE3 and comb-like projection PE3. Moreover, space width W1 between comb-like projection CE1 and comb-like projection PE1 is greater than space width W6 between comb-like projection PE3 and comb-like projection CE4.

More specifically, in the present embodiment, space width W1 at an edge of the display pixel PX is substantially 9.5 μm and space width W6 is substantially 9.3 μm. In contrast, space widths W2 to W5 in the center portion of the display pixel PX are substantially 6.2 μm.

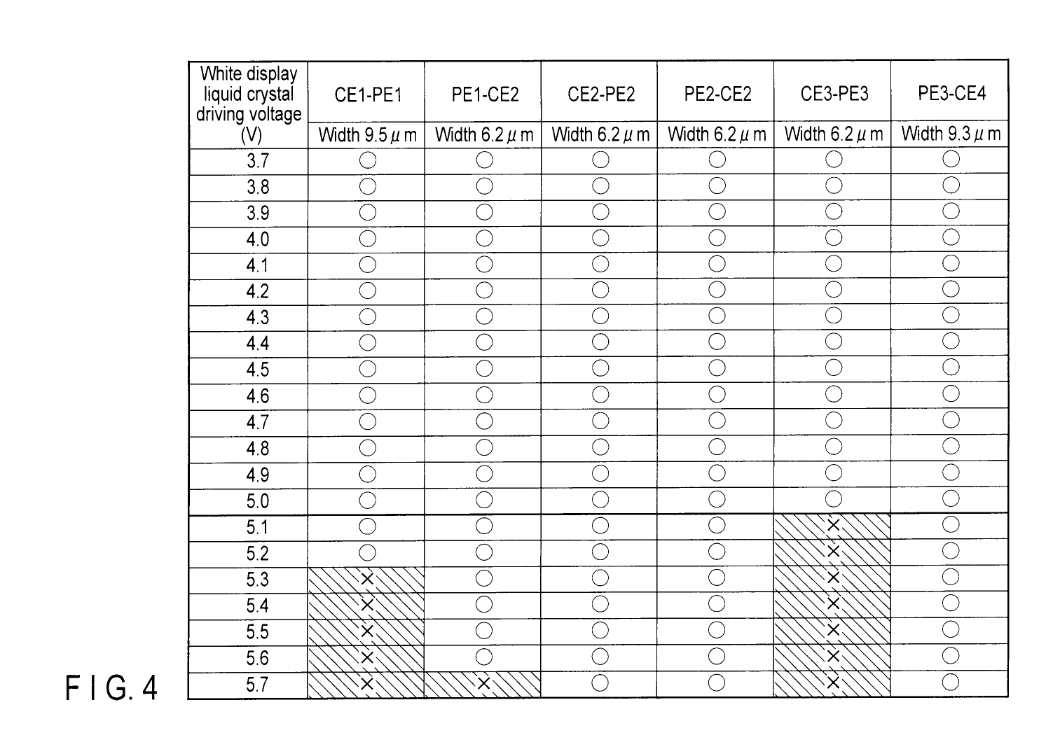

FIG. 4 shows an example of results of evaluating the generation of domains where the orientation state of the liquid crystal is not restored when pressing is stopped after the orientation state of the liquid crystal being disturbed by pressing in the liquid crystal display apparatus 1. In the present embodiment, whether a domain is generated between comb-like projections PE1 to PE3 and comb-like projections CE1 to CE4 is evaluated by changing a white display liquid crystal driving voltage from 3.7 to 5.7 V in increments of 0.1 V. In FIG. 4, “0” indicates that no domain is generated and “x” indicates that a domain is generated.

If the white display liquid crystal driving voltage ranges from 3.7 to 5.0 V, nowhere is a domain generated between comb-like projections PE1 to PE3 and comb-like projections CE1 to CE4. If the white display liquid crystal driving voltage ranges from 5.1 to 5.7 V, a domain is generated in the space between comb-like projection CE3 and comb-like projection PE3. If the white display liquid crystal driving voltage ranges from 5.3 to 5.7 V, a domain is further generated in the space between comb-like projection CE1 and comb-like projection PE1. If the white display liquid crystal driving voltage is 5.7 V, a domain is further generated in the space between comb-like projection PE1 and comb-like projection CE2.

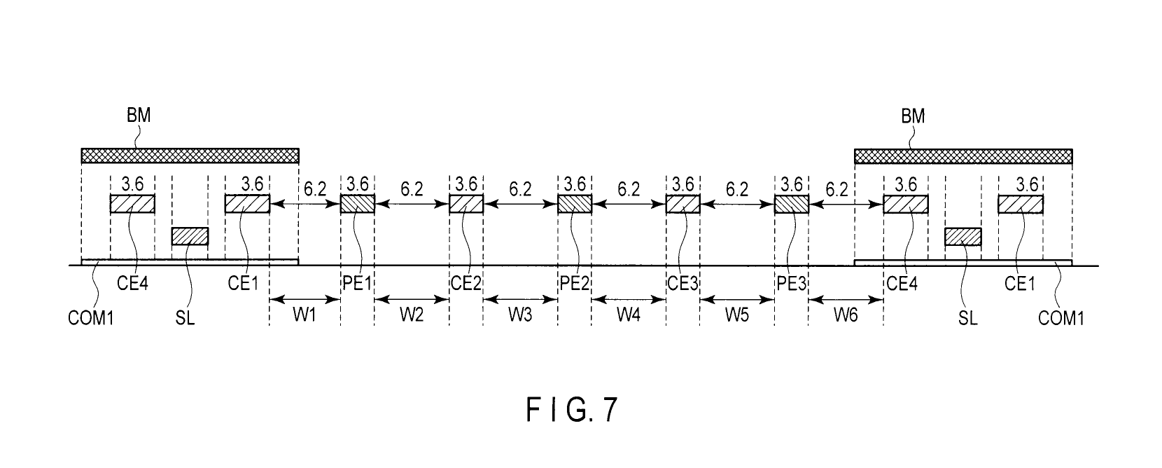

FIG. 7 schematically shows the arrangement positions of the pixel electrodes PE and the common electrodes CE of a liquid crystal display apparatus according to Comparative Example. In FIG. 7, as in FIG. 3, the light shielding portion COM1 of the common wire COM, comb-like projections PE1 to PE3 of the pixel electrode PE, comb-like projections CE1 to CE4 of the common electrode CE, the signal lines SL, and the light shielding layers are illustrated and other elements are omitted.

In Comparative Example, the width of comb-like projections PE1 to PE3 and comb-like projections CE1 to CE4 is substantially 3.6 μm and the width of the signal line SL is substantially 3.0 μm in the row direction D2 in which the display pixels PX are arrayed and the space widths between comb-like projections PE1 to PE3 of the pixel electrode PE and comb-like projections CE1 to CE4 of the common electrode CE are substantially equal and substantially 6.2 μm. The liquid crystal display apparatus according to Comparative Example is similar to the liquid crystal display apparatus 1 in the above embodiment excluding space widths W1 to W6.

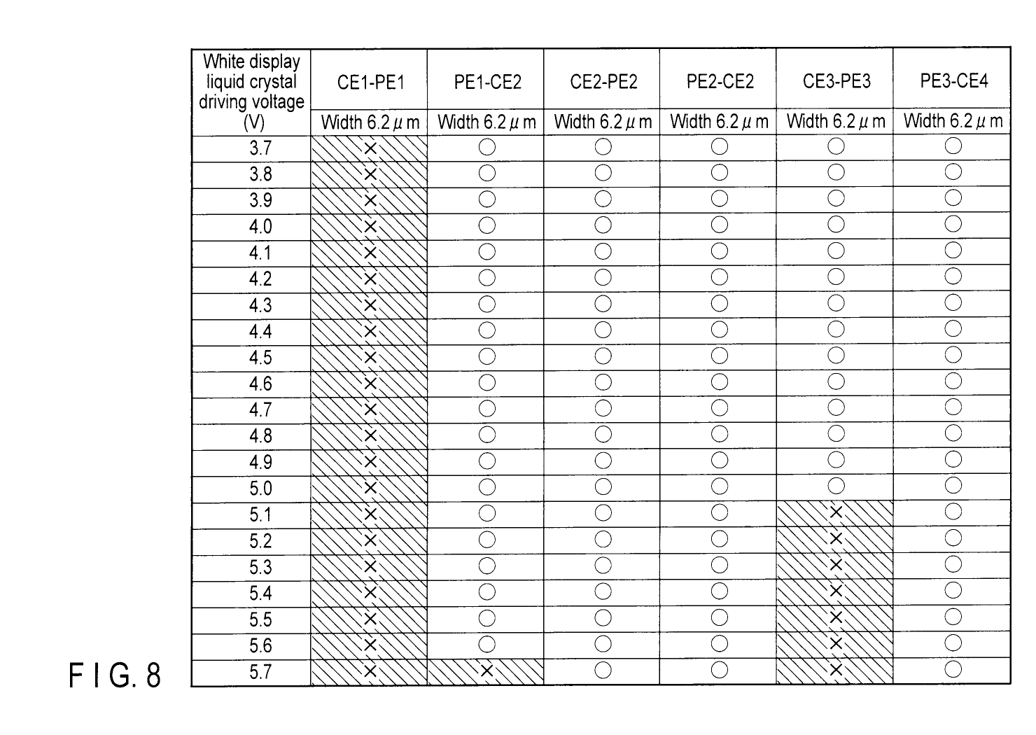

FIG. 8 shows an example of results of evaluating the generation of domains where the orientation state of the liquid crystal is not restored when pressing is stopped after the orientation state of the liquid crystal being disturbed by pressing in the liquid crystal display apparatus according to Comparative Example described above.

In the manner as shown in FIG. 4, whether a domain is generated between comb-like projections PE1 to PE3 and comb-like projections CE1 to CE4 is evaluated by changing the white display liquid crystal driving voltage from 3.7 to 5.7 V in increments of 0.1 V.

In all cases of the white display liquid crystal driving voltage ranging from 3.7 to 5.7 V, a domain is generated in the space between comb-like projection CE1 and comb-like projection PE1. If the white display liquid crystal driving voltage ranges from 5.1 to 5.7 V, a domain is further generated in the space between comb-like projection CE3 and comb-like projection PE3. If the white display liquid crystal driving voltage is 5.7 V, a domain is further generated in the space between comb-like projection PE1 and comb-like projection CE2.

Thus, in the liquid crystal display apparatus according to Comparative Example, the white display liquid crystal driving voltage is set to 3.7 V, which makes the white display dark. In the liquid crystal display apparatus 1 according to the present embodiment, by contrast, a bright white display is enabled by setting the white display liquid crystal driving voltage is set to 5.0 V.

That is, according to the liquid crystal display apparatus 1 in the present embodiment, a liquid crystal display apparatus of excellent display quality can be provided by suppressing the generation of domains.

Next, a liquid crystal display apparatus 1 according to the second embodiment will be described with reference to drawings. In the description that follows, the same reference numbers are attached to elements similar to elements in the first embodiment described above and a description thereof is omitted.

The liquid crystal display apparatus 1 in the present embodiment is different from the first embodiment described above in space widths W1 to W6 between comb-like projections PE1 to PE3 and comb-like projections CE1 to CE4.

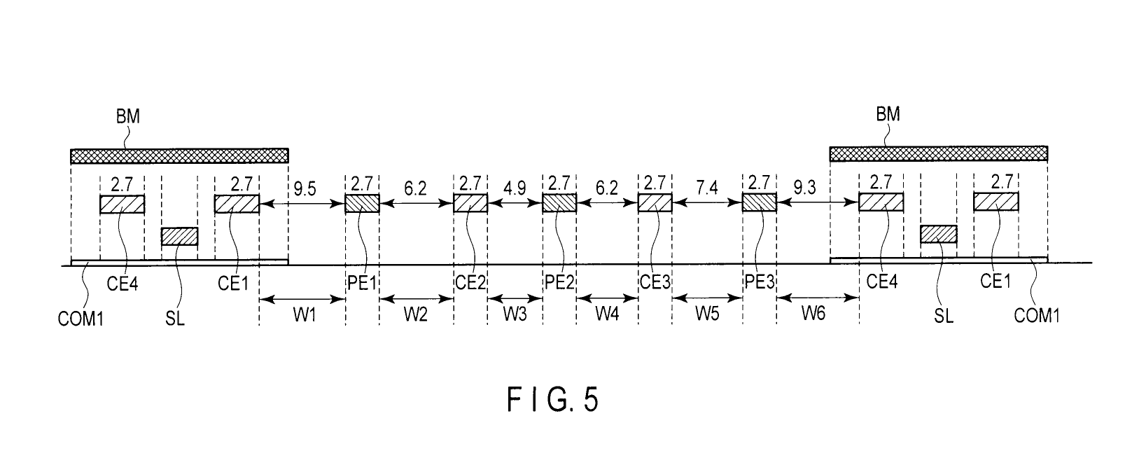

FIG. 5 schematically shows the arrangement positions of the pixel electrodes PE and the common electrodes CE in the section along line III-III in FIG. 2 in the liquid crystal display apparatus 1 according to the present embodiment. In FIG. 5, the light shielding portion COM1 of the common wire COM, comb-like projections PE1 to PE3 of the pixel electrode PE, comb-like projections CE1 to CE4 of the common electrode CE, the signal lines SL, and the light shielding layers are illustrated and other elements are omitted.

In the present embodiment, the width of comb-like projections PE1 to PE3 and comb-like projections CE1 to CE4 is substantially 2.7 μm and the width of the signal line SL is substantially 3.0 μm in the row direction D2 in which the display pixels PX are arrayed and the space widths between comb-like projections PE1 to PE3 of the pixel electrode PE and comb-like projections CE1 to CE4 of the common electrode CE are different in the pixel center portion.

That is, space widths W2, W3, W4 and W5 between comb-like projections PE1 to PE3 and comb-like projections CE2 and CE3 in the center portion between the adjacent signal lines SL in the row direction D2 are not equal.

In the present embodiment, among a plurality of space widths W2, W3, W4 and W5 between comb-like projections PE1 to PE3 and comb-like projections CE2 and CE3 in the center portion between the adjacent signal lines SL in the row direction D2, space width W5 between the first comb-like projection PE3 and the second comb-like projection CE3 from the side of the signal line SL supplying a video signal to the pixel electrode PE via the pixel switch SW is greater than the other space widths and space width W3 between the second comb-like projection PE2 and the third comb-like projection CE2 is smaller than the other space widths.

As in the first embodiment described above, space width W1 between comb-like projection CE1 arranged on the side of the signal line SL supplying a video signal to the pixel electrode PE of the adjacent display pixel PX of each display pixel PX and comb-like projection PE1 arranged adjacent to comb-like projection CE1 and space width W6 between comb-like projection CE4 arranged on the side of the signal line SL supplying a video signal to the pixel electrode PE of the display pixel PX and comb-like projection PE3 arranged adjacent to comb-like projection CE4 are greater than space width W2 between comb-like projection PE1 and comb-like projection CE2, space width W3 between comb-like projection CE2 and comb-like projection PE2, space width W4 between comb-like projection PE2 and comb-like projection CE3, and space width W5 between comb-like projection CE3 and comb-like projection PE3. Moreover, space width W1 between comb-like projection CE1 and comb-like projection PE1 is greater than space width W6 between comb-like projection PE3 and comb-like projection CE4.

More specifically, in the present embodiment, space width W1 is substantially 9.5 μm and space width W6 is substantially 9.3 μm. Widths W2 and W4 are substantially 6.2 μm, space width W3 is 4.9 μm, and space width W5 is 7.4 μm.

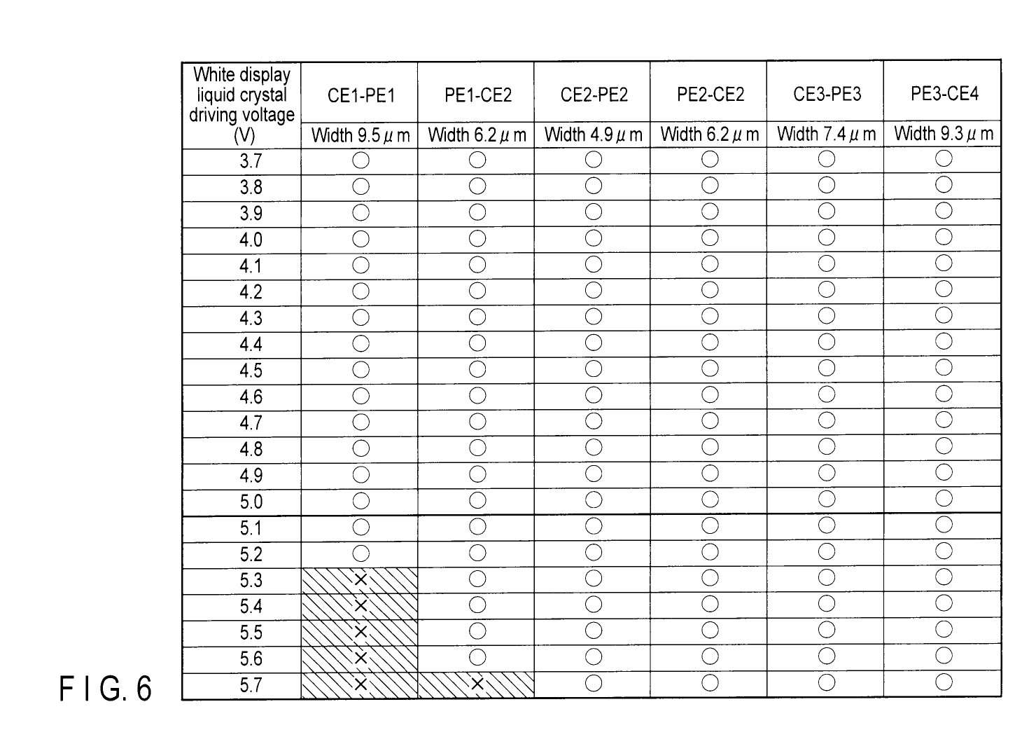

FIG. 6 shows an example of results of evaluating the generation of domains where the orientation state of the liquid crystal is not restored when pressing is stopped after the orientation state of the liquid crystal being disturbed by pressing in the liquid crystal display apparatus 1. In the present embodiment, whether a domain is generated between comb-like projections PE1 to PE3 and comb-like projections CE1 to CE4 is evaluated by changing a white display liquid crystal driving voltage from 3.7 to 5.7 V in increments of 0.1 V. In FIG. 4, “0” indicates that no domain is generated and “x” indicates that a domain is generated.

If the white display liquid crystal driving voltage ranges from 3.7 to 5.2 V, nowhere is a domain generated between comb-like projections PE1 to PE3 and comb-like projections CE1 to CE4. If the white display liquid crystal driving voltage ranges from 5.3 to 5.7 V, a domain is generated in the space between comb-like projection CE1 and comb-like projection PE1. If the white display liquid crystal driving voltage is 5.7 V, a domain is further generated in the space between comb-like projection PE1 and comb-like projection CE2.

Thus, in the liquid crystal display apparatus according to the present embodiment, a brighter white display than the liquid crystal display apparatus according to Comparative Example described above can be enabled by setting the white display liquid crystal driving voltage to 5.2 V. Further, in the present embodiment, the generation of domains can be suppressed more than in the first embodiment described above and therefore, a brighter white display can be realized.

That is, according to the liquid crystal display apparatus 1 in the present embodiment, a liquid crystal display apparatus of excellent display quality can be provided by suppressing the generation of domains.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display apparatus, comprising:
a first substrate that comprises a plurality of pixel electrodes including a plurality of comb-like projections extending in a first direction and arranged in a second direction substantially perpendicular to the first direction, a plurality of common electrodes including a plurality of comb-like projections extending in the first direction between the comb-like projections of the pixel electrode and arranged with a predetermined spacing from the comb-like projections of the pixel electrode, a scanning line extending along the second direction, and a signal line extending along the first direction;
a second substrate arranged opposite to the first substrate; and
a liquid crystal layer sandwiched between the first substrate and the second substrate, wherein
a space width between the comb-like projection of the pixel electrode and the comb-like projection of the common electrode arranged near the signal line in the second direction is greater than a space width between the comb-like projection of the pixel electrode and the comb-like projection of the common electrode in a center portion between the adjacent signal lines.

2. The liquid crystal display apparatus according to claim 1, wherein a plurality of space widths between the comb-like projection of the pixel electrode and the comb-like projection of the common electrode in the center portion between the adjacent signal lines in the second direction are different.

3. The liquid crystal display apparatus according to claim 1, wherein the first substrates further comprises a pixel switch that switches a connection between the signal line and the pixel electrode,
the pixel electrode comprises three comb-like projections,
the common electrode comprises four comb-like projections, and
the space width between the comb-like projection of the pixel electrode and the comb-like projection of the common electrode arranged near the signal line in the second direction is the space width between the first comb-like projection of the common electrode and the first comb-like projection of the pixel electrode from a side of the signal line supplying a video signal to the pixel electrode via the pixel switch and the space width between the fourth comb-like projection of the common electrode and the third comb-like projection of the pixel electrode.

4. The liquid crystal display apparatus according to claim 3, wherein among a plurality of the space widths between the comb-like projection of the common electrode and the comb-like projection of the pixel electrode in the center portion between the adjacent signal lines in the second direction, the space width between the first comb-like projection of the pixel electrode and the second comb-like projection of the common electrode from the side of the signal line supplying the video signal to the pixel electrode via the pixel switch is greater than the other space widths and the space width between the second comb-like projection of the pixel electrode and the third comb-like projection of the common electrode is smaller than the other space widths.

5. A liquid crystal display apparatus, comprising:
a display region including a plurality of pixels arranged in a matrix form;
a first substrate that comprises a plurality of pixel electrodes including a plurality of comb-like projections extending in a first direction and arranged in a second direction substantially perpendicular to the first direction, a plurality of common electrodes including a plurality of comb-like projections extending in the first direction between the comb-like projections of the pixel electrode and arranged with a predetermined spacing from the comb-like projections of the pixel electrode;
a second substrate arranged opposite to the first substrate; and
a liquid crystal layer sandwiched between the first substrate and the second substrate, wherein
in each pixel, space widths between the comb-like projections of the pixel electrode and the comb-like projections of the common electrode in the second direction are different between the pixel center portion and a pixel edge.
